(19) United States
(12) Patent Application Publication
(10) Pub. No.: US 2009/0009880 A1
(43) Pub. Date: Jan. 8, 2009

(54) MULTI-FOCAL PICK-UP DEVICE FOR OPTICAL STORAGE SYSTEM AND FLUID ZOOM LENS THEREOF

(76) Inventor: Fung-Hsu Wu, Tao-Yuan Hsien (TW)

Correspondence Address: NORTH AMERICA INTELLECTUAL PROPERTY CORPORATION, P.O. BOX 506, MERRIFIELD, VA, 22116, US

(21) Appl. No.: 12/129,702

(22) Filed: May 30, 2008

(30) Foreign Application Priority Data
Jul. 5, 2007 (TW) 096124534

(51) Int. Cl. G02B 1/06

(52) U.S. Cl. 359/666

(57) ABSTRACT

A multi-focal pick-up device for an optical storage system includes a light source and a fluid zoom lens. The fluid zoom lens is disposed along the optical axis of the light source. The fluid zoom lens includes a plurality of fluid layers. The fluid layers are immiscible to each other, and interfaces of the fluid layers have at least one curved surface. The curved surface can be adjusted by providing at least one voltage differential being applied to the fluid layers so as to form an adjustable curvature for the curved surface.

### BACKGROUND OF THE INVENTION

1. Field of the Invention

The present invention relates to a multi-focal pick-up device for an optical storage system and a fluid zoom lens thereof, and more particularly, to a multi-focal pick-up device having adjustable focal length for an optical storage system and a fluid zoom lens thereof, in order to read data from various substrate thicknesses of storage media.

2. Description of the Prior Art

By the development of technology, storage media with higher storage capacity are required. Conventional compact discs (CD) can no longer satisfy the higher capacity requirements, so that the digital versatile disc (DVD) is used instead. Compared to the storage capacity of conventional CDs of being 700 MB, the storage capacity of DVD with 4.7 GB per side has become the most popular storage medium. However, the optical storage system for the DVD requires a pick-up device having an numerical aperture of 0.6 to read the data in DVD of substrate thickness of 0.6 mm. Therefore, it is different from the pick-up device of CDs having numerical aperture of 0.45. For reading the data both in CD and the DVD by the same drive, it is inevitable to integrate the pick-up devices.

Please refer to FIG. 1 to FIG. 3, FIG. 1 is a schematic diagram illustrating a conventional pick-up device having adjustable numerical aperture with two electrodes under open circuit condition. FIG. 2 is a schematic diagram illustrating the conventional pick-up device having adjustable numerical aperture when the two electrodes connected to each other. FIG. 3 is a schematic diagram illustrating a cross-sectional view and a top view of the liquid crystal device of the conventional pick-up device. The conventional pick-up device 10 comprises a liquid crystal device 12, a polarizing beam splitter (PBS) 20, and a lens 22. As shown in FIG. 3, the liquid crystal device 12 comprises two electrodes 16, 18 and a liquid crystal layer 14 disposed between the electrodes 16, 18. The electrodes 16, 18 are respectively disposed on outer side of the liquid crystal layer 14. The optical axis passes through the center of the liquid crystal layer 14. As shown in FIG. 1, when the electrodes 16, 18 are under open circuit condition, the liquid crystal layer 14 plays the role of a birefringent medium which rotates the polarization of the incident light beam by 90 degrees, so that the light beam with the rotated polarization can wholly pass through the PBS 20 and reach the lens 22. And then, the light beam is focused on the DVD 24 through the lens 22 to read the data in the DVD. In this time, the numerical aperture of the conventional pick-up device 10 can be the numerical aperture for reading DVD. As shown in FIG. 2, when the electrodes 16, 18 are under connected circuit condition, the electrodes 16, 18 generate a voltage to change the refractive index of the liquid crystal layer 14. The polarization of the light beam does not been changed after passing through the liquid crystal layer 14 having the voltage differential. However, the polarization of the light beam is changed after passing through the liquid crystal layer 14 having no voltage differential. Therefore, the outer part of the light beam without changing the polarization cannot pass through the PBS 20. Only the central part of the light beam with changed polarization can pass through the PBS 20. Therefore, after passing through the liquid crystal layer 14, the PBS 20 and the lens 22, the light beam can be focused on the CD 26 by. In the meantime the numerical aperture of the conventional pick-up device 10 is the numerical aperture for picking up CD 26.

However, the blue-ray disc (BD) with higher storage capacity is come out recently, so that the aforementioned conventional technologies cannot overcome the obstacles in reading data for all CD, DVD, and BD. Furthermore, because the BD with the storage capacity of 25 GB per layer has tremendous marketing potential in the future, it becomes an important object in the industry to overcome the obstacle when reading among the BD with substrate thickness of 0.1 mm, the DVD with substrate thickness of 0.6 mm, and the CD with substrate thickness of 1.2 mm.

### SUMMARY OF THE INVENTION

The present invention is related to an object to provide a liquid multi-focal pick-up device for an optical storage system and a fluid zoom lens thereof to read data in various kinds of discs with different substrate thicknesses.

According to the invention, a multi-focal pick-up device for an optical storage system is provided. The multi-focal pick-up device for the optical storage system comprises a light source used to emit a light beam, and a fluid zoom lens disposed along an optical axis of the light beam. The fluid zoom lens comprises a plurality of fluid layers which are immiscible to each other; and the interfaces of the fluid layers comprising at least one curved surface; and the curved surface being able to be adjusted by providing a voltage differential being applied to the fluid layers, so as to adjust a light path for a liquid multi-focal pick-up device.

According to the invention, a fluid zoom lens is provided. The fluid zoom lens comprises: a fluid chamber, comprising a first transparent layer and a second transparent layer; a first fluid layer, disposed in the fluid chamber and close to a side of the first transparent layer; a second fluid layer, disposed in the fluid chamber, and the second fluid layer is between the first fluid layer and the second transparent layer; and a third fluid layer, disposed in the fluid chamber, and the third fluid layer is between the second fluid layer and the second transparent layer; and the first fluid layer, the second fluid layer and the third fluid layer fill the fluid chamber, and are immiscible to each other. An interface between the first fluid layer and the second fluid layer is to form a first curved surface; an interface between the second fluid layer and the third fluid layer is to form a second curved surface; and the first curved surface and the second curved surface are being able to be adjusted by providing a voltage differential applied to the first fluid layer, the second fluid layer, and the third fluid layer, so as to achieve multi-focusing by adjusting curvatures for the first curved surface and the second curved surface, respectively.

According to the invention, a fluid zoom lens is further provided. The fluid zoom lens comprises: a fluid chamber, comprising a first transparent layer and a second transparent layer; a first fluid layer, disposed in the fluid chamber, and the first fluid layer is close to a side of the first transparent layer; and a second fluid layer, disposed in the fluid chamber, and the second fluid layer is between the first fluid layer and the second transparent layer; and the first fluid layer and the second fluid layer fill the fluid chamber, and are being immiscible to each other. An interface between the first fluid layer and the second fluid layer is to form a curved surface; and the curved surface is adjusted by providing a voltage differential being applied to the first fluid layer and the second fluid layer, so as to achieve multi-focusing by adjusting a curvature of the curved surface.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram illustrating a conventional pick-up device having adjustable numerical aperture with two electrodes under open circuit condition.

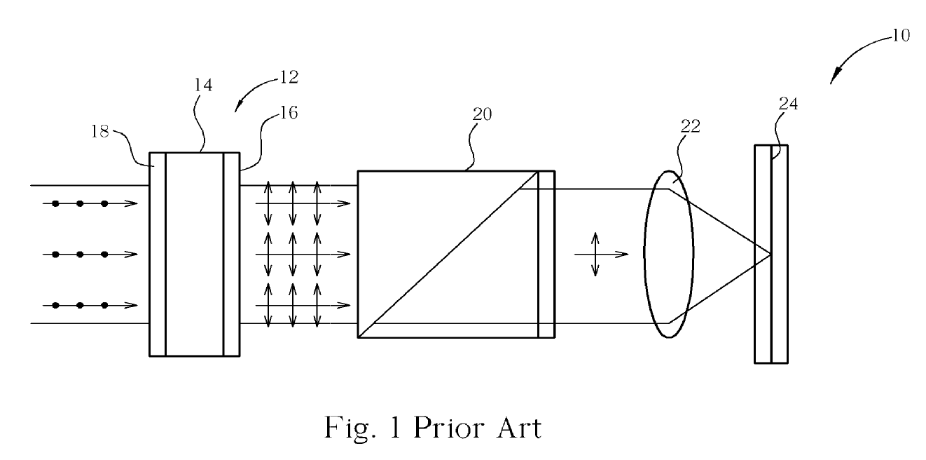

FIG. 2 is a schematic diagram illustrating the conventional pick-up device having adjustable numerical aperture when two electrodes connected to each other.

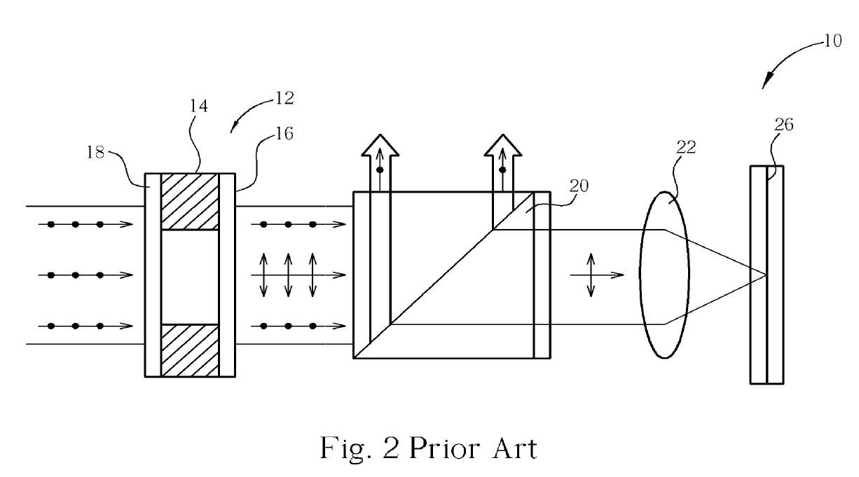

FIG. 3 is a schematic diagram illustrating a cross-sectional view and a top view of the liquid crystal device of the conventional pick-up device.

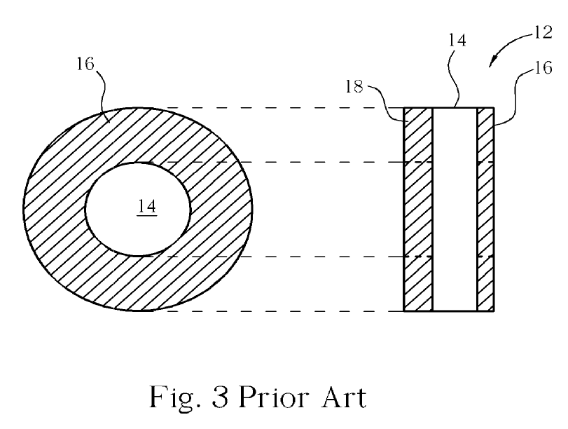

FIG. 4 is a schematic diagram illustrating a multi-focal pick-up device for an optical storage system, according to a first preferred embodiment of the present invention.

FIG. 5 is a schematic diagram illustrating a lens being disposed between the light source and the fluid zoom lens, according to the first preferred embodiment of the present invention.

FIG. 6 is a schematic diagram illustrating a multi-focal pick-up device for the optical storage system, according to a second preferred embodiment of the present invention.

FIG. 7 is a schematic diagram illustrating a multi-focal pick-up device for the optical storage system, according to a third preferred embodiment of the present invention.

FIG. 8 is a schematic diagram illustrating a multi-focal pick-up device for the optical storage system, according to a fourth preferred embodiment of the present invention.

FIG. 9 is a schematic diagram illustrating a multi-focal pick-up device for the optical storage system according to a fifth preferred embodiment of the present invention.

FIG. 10 is a schematic diagram illustrating a multi-focal pick-up device for the optical storage system according to a sixth preferred embodiment of the present invention.

### DETAILED DESCRIPTION

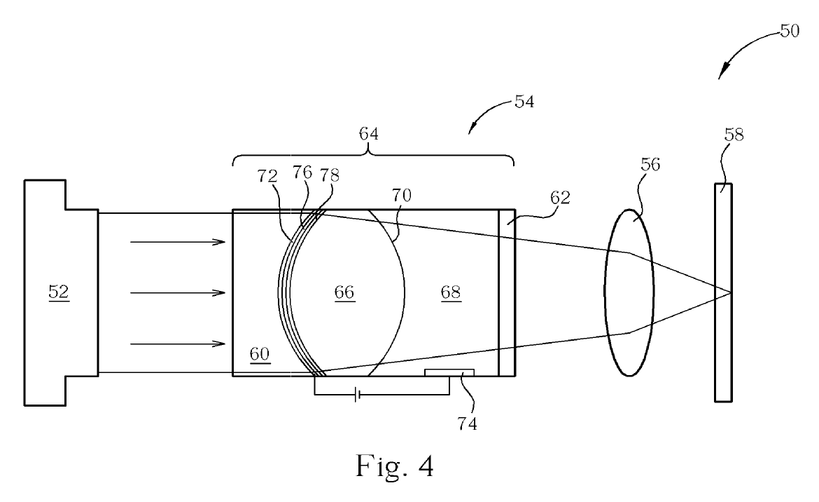

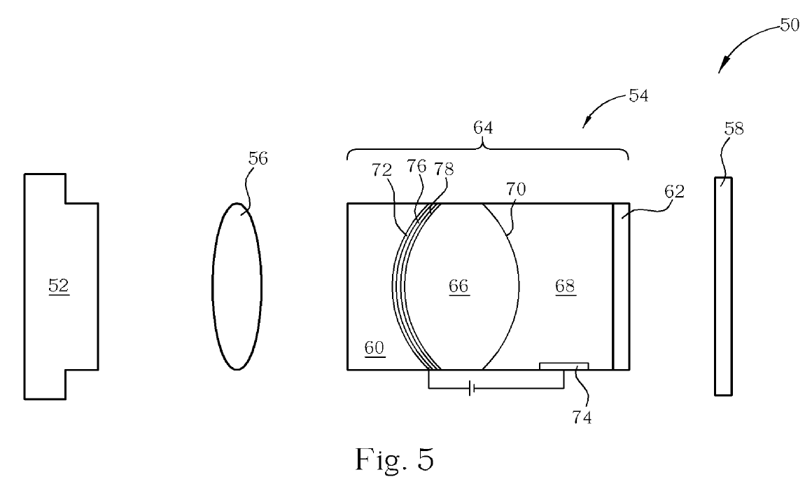

Please refer to FIG. 4. FIG. 4 is a schematic diagram illustrating a multi-focal pick-up device for an optical storage system, according to a first preferred embodiment of the present invention. As shown in FIG. 4, the multi-focal pick-up device 50 for the optical storage system comprises a light source 52 and a fluid zoom lens 54. The light source 52 can be a laser diode adapted to provide a laser light beam to pick up a storage medium 58. The wavelength of the light source 52 can be determined according to types of storage media 58, such as CD, DVD, or BD. For example, the light source used to pick up CD is a red laser diode with a wavelength of 780 nm. The light source used to pick up DVD is a red laser diode with a wavelength of 650 nm. The light source used to pick up BD is a blue laser diode with a wavelength of 405 nm. The fluid zoom lens 54 is disposed along an optical axis of the emitted light beam from the light source 52, so that the light beam can be focused on a storage medium 58 after passing through the fluid zoom lens 54. The data in the storage medium 58 can thereby be read. In addition, the multi-focal pick-up device 50 further comprises a lens 56; and the fluid zoom lens 54 is disposed between the light source 52 and the lens 56. Because of the aforementioned arrangement, the light beam emitted from the light source 52 can be better focused on the storage medium 58 to prevent aberration. But the present invention is not limited to this. Please refer to FIG. 5. FIG. 5 is a schematic diagram illustrating the lens 56 being disposed between the light source 52 and the fluid zoom lens 54 according to the first preferred embodiment of the present invention. As shown in FIG. 5, the lens 56 also can be disposed between the light source 52 and the fluid zoom lens 54.

Please refer to FIG. 4. A fluid chamber 64 comprises the first transparent layer 60 and the second transparent layer 62. The fluid zoom lens 54 comprises a fluid chamber 64, which comprises a first fluid layer 66 close to a side of a first transparent layer 60 in the fluid chamber 64, and a second fluid layer 68 disposed in the fluid chamber 64. The second fluid layer 68 is between the first fluid layer 66 and the second transparent 62; and the first fluid layer 66 and the second fluid layer 68 fill the entire fluid chamber 64; and the first fluid layer 66 and the second fluid layer 68 are mutually immiscible, so that an interface between the first fluid layer 66 and the second fluid layer 68 is to form a first curved surface 70. To achieving multi focusing as an adjustable curvature, the first curved surface 70 can be adjusted by applying a voltage differential to the first fluid layer 66 and the second fluid layer 68. The material for the first fluid layer 66 can be a nonconductive fluid, such as silicone oil. The material for the second fluid layer 68 can be a conductive fluid, such as salt solution. The shape of the fluid chamber 64 can be cylindrical or cuboid, but is not limited to this.

In this preferred embodiment, the first transparent layer 60 in the fluid chamber 64 is disposed at a side wherein the light beam enters; and the second transparent layer 62 in the fluid chamber 64 is disposed at the other side wherein the light beam exits. The first transparent layer 60 and the second transparent layer 62 seal off the first fluid layer 66 and the second fluid layer 68 inside the fluid zoom lens 54. For the first transparent layer 60, the surface facing the first fluid layer 66 is a fixed curved surface, so the incident light beam can show the focusing effect after passing through the interface between the first transparent layer 60 and the first fluid layer 66. But the present invention is not limited to this. The surface of the first transparent layer 60 facing the first fluid layer 66 also can be a flat surface. In addition, the first transparent layer 60 and the second transparent layer 62 can be of a transparent material, such as glass or clear plastics.

The fluid zoom lens 54 further comprises a first electrode 72, which is disposed between the first fluid layer 66 and the first transparent layer 60, and a second electrode 74. The second electrode 74 is electrically connected to the second fluid layer 68. In this preferred embodiment, the second electrode 74 is disposed on the inner sidewall of the fluid chamber 64, and the second electrode 74 is used to electrically connect to the second fluid layer 68, however, the disposition of the second electrode 74 is not limited to this. The second electrode 74 can also be in other forms and to be at different positions to connect to the second fluid layer 68. In addition, the fluid zoom lens 54 further comprises a first insulating layer 76, which is disposed between the first electrode 72 and the first fluid layer 66, and a first dielectric layer 78, which is disposed between the first insulating layer 76 and the first fluid layer 66. The first dielectric layer 78 is in contact with the first fluid layer 66. But the dispositions of the insulating layer 76 and the first dielectric layer 78 are not limited to this. The position of the first insulating layer 76 and the position of the first dielectric layer 78 also can be switched, so that the insulating layer 76 is in contact with the first fluid layer 66. In this preferred embodiment, the first electrode 72 and the second electrode 74 are respectively electrically connected to a voltage source's anode and cathode, so as to provide a voltage differential between the first electrode 72 and the second electrode 74. The voltage differential generates positive electric charges and negative electric charges at the interface between the first insulating layer 76 and the first electrode 72 and the interface between the first fluid layer 66 and the second fluid layer 68 respectively, to change the surface tension of the first fluid layer 66; the aforementioned situation is called the electrowetting. As a result, the shape of the first fluid layer 66 is changed because of the electrowetting, and thereby adjusting the curvature radius of the first curved surface 70. With changing of the curvature radius for the first curved surface 70, the degree of convergence of the light beam also is varied while light beam passes through the fluid zoom lens 54; and the focal length of the fluid zoom lens 54 is thereby changed. Therefore, through adjusting the voltage differential the fluid zoom lens 54 of the present invention can have an adjustable focal length so as to fulfill the requirements of different numerical apertures. As a result, the discs with different substrate thicknesses can thereby be read. For example, in this preferred embodiment, the material of the first transparent layer 60 and the second transparent layer 62 are glasses with a refractive index of 1.505. The first fluid layer 66 is silicone oil with a refractive index of 1.409. The second fluid layer 68 is salt solution with a refractive index of 1.330. The curvature radius of the fixed curved surface is −5 cm. When the voltage differential between the first electrode 72 and the second electrode 74 is zero, the curvature radius of the first curved surface 70 is 1.59 cm, and the focal length of the fluid zoom lens 54 is 2.34 cm. When the voltage differential between the first electrode 72 and the second electrode 74 is 100 volts, the curvature radius of the first curved surface 70 is changed to 3.5 cm, and the focal length of the fluid zoom lens 54 is changed to 2.15 cm. Therefore, the focal length of the fluid zoom lens 54 can be changed by adjusting the voltage differential between the first electrode 72 and the second electrode 74, so that the light beam can be focused on different planes.

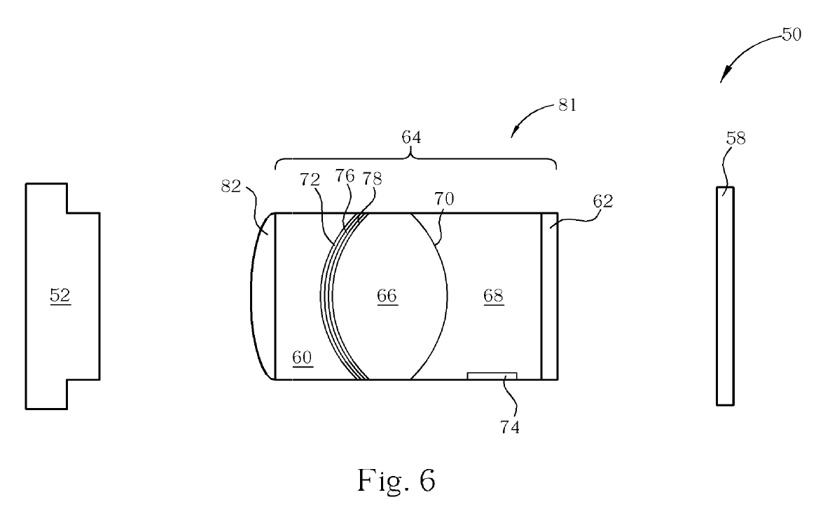

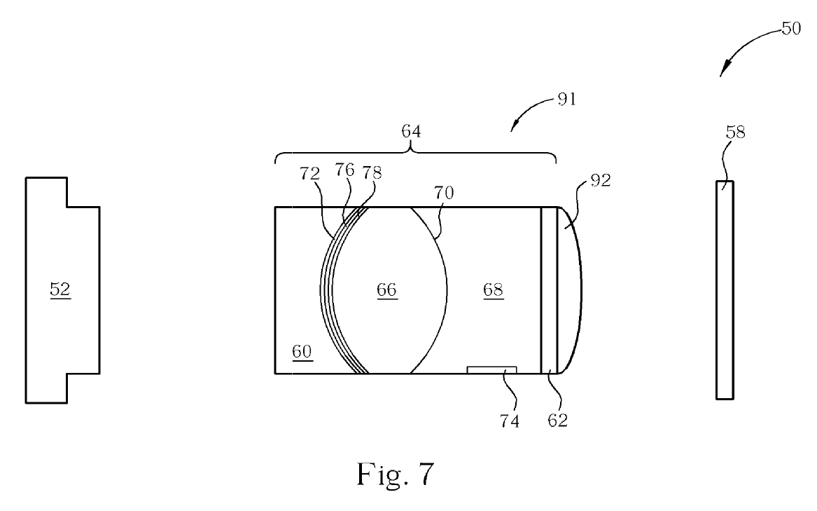

However, the multi-focal pick-up device for the optical storage system of the present invention is not limited to the first preferred embodiment, and the fluid zoom lens is workable in the form of other structures. For convenience, like elements are denoted by like numerals, and like elements are not detailed redundantly. Please refer to FIG. 6 and FIG. 7. FIG. 6 is a schematic diagram illustrating a multi-focal pick-up device for the optical storage system, according to a second preferred embodiment of the present invention. FIG. 7 is a schematic diagram illustrating a multi-focal pick-up device for the optical storage system, according to a third preferred embodiment of the present invention. As shown in FIG. 6, as compared to the first preferred embodiment, the fluid zoom lens 81 of the present embodiment further comprises a lens 82, which is disposed on a surface of the fluid zoom lens 81 for enhancing the focusing accuracy of the fluid zoom lens 81. Furthermore, the lens 56 of the multi-focal pick-up device 50 in the first preferred embodiment also can be reduced, and also having the size of the multi-focal pick-up device reduced as well. The disposition of the lens 82 is not limited to this. As shown in FIG. 7, the lens 92 can be further disposed on a surface of the fluid zoom lens 81 wherein the light beam exits.

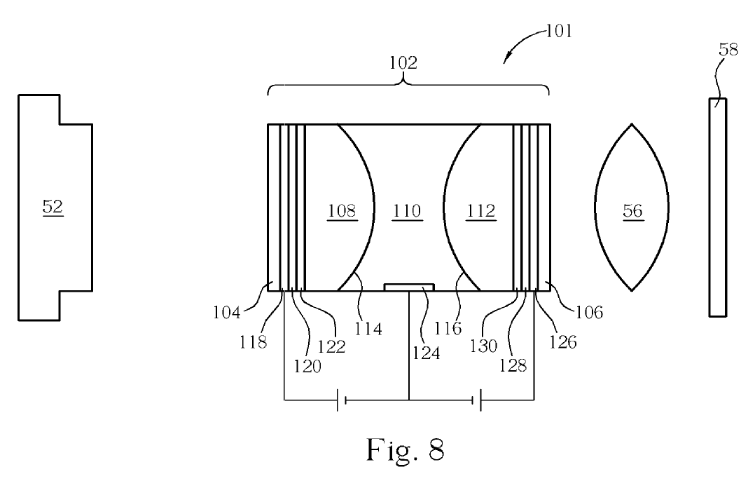

Furthermore, the fluid zoom lens 54 of the present invention is not limited to have only two fluid layers as described in the above-mentioned preferred embodiments. The fluid zoom lens 54 also can have three fluid layers. Please refer to FIG. 8. FIG. 8 is a schematic diagram illustrating a multi-focal pick-up device for the optical storage system according to a fourth preferred embodiment of the present invention. As shown in FIG. 8, as compared to the first preferred embodiment, the fluid zoom lens 101 of this embodiment comprises a fluid chamber 102 which is comprising a first transparent layer 104 and a second transparent layer 106, a first fluid layer 108 close to a side of the first transparent layer 104 in the fluid chamber 102, a second fluid layer 110 disposed in the chamber 102, and a third fluid layer 112 disposed in the chamber 102. The second fluid layer 110 is between the first fluid layer 108 and the second transparent layer 106; and the third fluid layer 112 is between the second fluid layer 110 and the second transparent layer 106. In addition, the first fluid layer 108, the second fluid layer 110, and the third fluid layer 112 fill the fluid chamber 102, and are immiscible to each other. An interface between the first fluid layer 108 and the second fluid layer 110 is a first curved surface 114; and an interface between the second fluid layer 110 and the third fluid layer 112 is a second curved surface 116. The first curved surface 114 and the second curved surface 116 can be adjusted by providing at least one voltage differential being applied to the first fluid layer 108, the second fluid layer 110, and the third fluid layer 112, so as to form an adjustable curvature for the first curved surface 114 and the second curved surface 116, respectively. In addition, an interface between the first transparent layer 104 and the first fluid layer 108 and an interface between the second transparent layer 106 and the third fluid layer 112 are both flat planes.

The fluid zoom lens 101 further comprises a first electrode 118 disposed between the first transparent layer 104 and the first fluid layer 108, a second electrode 124, and a third electrode 126 disposed between the second transparent layer 106 and the third fluid layer 112, wherein the second electrode 124 is electrically connected to the second fluid layer 110. The first electrode 118 and the second electrode 124 are respectively electrically connected to an anode and a cathode of a voltage source; and the second electrode 124 and the third electrode 126 are respectively electrically connected to an anode and a cathode of the same voltage source or another voltage source. The fluid zoom lens 101 further comprises a first insulating layer 120 disposed between the first transparent layer 104 and the first fluid layer 108, a first dielectric layer 122 disposed between the first insulating layer 120 and the first fluid layer 108, a second insulating layer 128 which is disposed between the third electrode 126 and the third fluid layer 112, and a second dielectric layer 130 disposed between the second insulating layer 128 and the third fluid layer 112. The first fluid layer 108 is in contact with the first dielectric layer 122; and the third fluid layer 112 is in contact with the second dielectric layer 130. As compared to the first preferred embodiment, the fluid zoom lens 101 of the present preferred embodiment further comprise the third fluid layer 112, the third electrode 126, the second insulating layer 128, and the second dielectric layer 130. The second curved surface 116 also can be adjusted through adjusting the voltage differential between the second electrode 124 and the third electrode 126 to form another adjustable curved surface. Therefore, the present preferred embodiment has two adjustable curved surfaces. The light beam can be better focused on the medium plane that requires to be read in. For example, the materials of the first transparent layer 104 and the second transparent layer 106 are glasses with a refractive index of 1.505. The material of the first fluid layer 108 and the third fluid layer 112 are silicone oil with a refractive index of 1.409. The material of second fluid layer 110 is salt solution with a refractive index of 1.330. When both the voltage differentials between the first electrode 118 and the second electrode 124 and between the second electrode 124 and the third electrode 126 are zero, the curvature radius of the first curved surface 114 is −4 cm, and the curvature radius of the second curved surface 116 is 4 cm. The focal length of the fluid zoom lens 101 is 1.25 cm. When both the voltage differentials between the first electrode 118 and the second electrode 124 and the between the second electrode 124 and the third electrode 126 are 80 volts, the curvature radius of the first curved surface 114 is changed to −6 cm, and the curvature radius of the second curved surface 116 is changed to 6 cm. The focal length of the fluid zoom lens 101 is changed to −1 cm. Therefore, the focal length of the fluid zoom lens 101 can be changed by adjusting the voltage differential between the first electrode 118 and the second electrode 124 and the voltage differential between the second electrode 124 and the third electrode 126, so that the light beam can be focused on different planes.

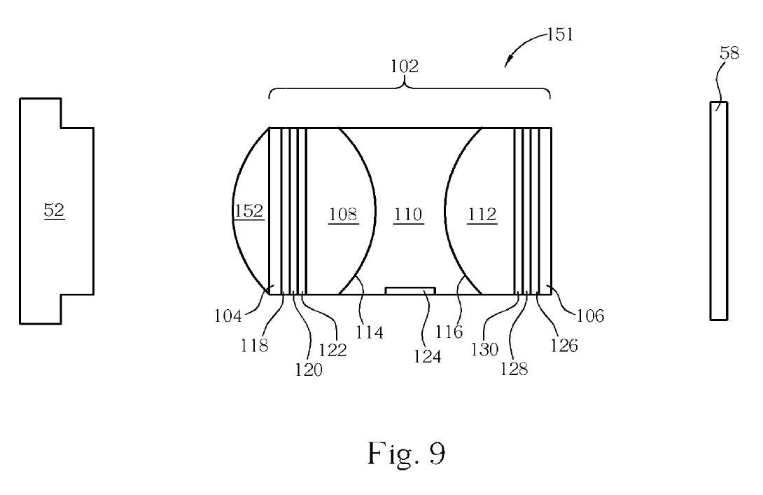

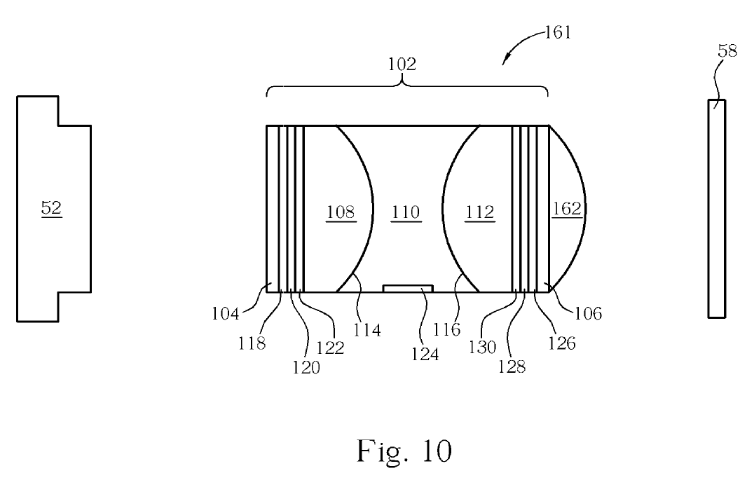

Please refer to FIG. 9 and FIG. 10. FIG. 9 is a schematic diagram illustrating a multi-focal pick-up device for the optical storage system, according to a fifth preferred embodiment of the present invention. FIG. 10 is a schematic diagram illustrating a multi-focal pick-up device for the optical storage system, according to a sixth preferred embodiment of the present invention. For convenience, like elements as the fourth embodiment are denoted by like numerals, the elements are not detailed redundantly. As shown in FIG. 9, compared to the fourth preferred embodiment, the fluid zoom lens 151 of the present embodiment further comprises a lens 152 disposed on a surface of the fluid zoom lens 151, wherein the light beam enters, so as to enhance the focusing accuracy of the fluid zoom lens 151. The lens 56 of the multi-focal pick-up device 50 in the first preferred embodiment also can be reduced, and also having the size of the multi-focal pick-up device smaller as well. The disposition of the lens 152 is not limited to this. As shown in FIG. 10, the lens 162 can be further disposed on a surface of the fluid zoom lens 161 wherein the light beam exits.

In summary, the present invention provides a multi-focal pick-up device having the fluid zoom lens with adjustable focal length. According to the substrate thickness of the storage medium that needs to be read in, the focal length of the fluid zoom lens can be changed by adjusting the voltage differential between the fluid zoom lens so as to allow the light beam to be focused on the storage medium. Therefore, the multi-focal pick-up device for the optical storage system of the present invention can improve upon the ability for picking up different discs having different substrate thicknesses.

Those skilled in the art will readily observe that numerous modifications and alterations of the device and method may be made while retaining the teachings of the invention.

What is claimed is:

1. A multi-focal pick-up device for an optical storage system, comprising:
a light source, for emitting a light beam; and
a fluid zoom lens, disposed along an optical axis of the light beam; the fluid zoom lens comprising a plurality of fluid layers immiscible to each other, and the interfaces of the fluid layers comprising at least one curved surface, and the curved surface being able to be adjusted by providing at least one voltage differential being applied to the fluid layers, so as to form an adjustable curvature for the curved surface.

2. The multi-focal pick-up device for an optical storage system of claim 1, wherein the fluid layers comprises a first fluid layer and a second fluid layer.

3. The multi-focal pick-up device for an optical storage system of claim 2, wherein the fluid zoom lens further comprises a first transparent layer and a second transparent layer sealing the fluid layers inside the fluid zoom lens, and the first transparent layer being disposed at a surface of the fluid zoom lens wherein the light beam enters, and the second transparent layer being disposed at the other surface of the fluid zoom lens wherein the light beam exits.

4. The multi-focal pick-up device for an optical storage system of claim 3, wherein a surface of the first transparent layer facing the first fluid layer is a fixed curved surface.

5. The multi-focal pick-up device for an optical storage system of claim 3, therein a surface of the first transparent layer facing the first fluid layer is a flat surface.

6. The multi-focal pick-up device for an optical storage system of claim 3, wherein the fluid zoom lens further comprises a first electrode, and the first electrode is disposed between the first transparent layer and the first fluid layer.

7. The multi-focal pick-up device for an optical storage system of claim 6, wherein the fluid zoom lens further comprises a first insulating layer and a first dielectric layer, and the first insulating layer and the first dielectric layer are disposed between the first transparent layer and the first fluid layer.

8. The multi-focal pick-up device for an optical storage system of claim 3, wherein the fluid layers further comprise a third fluid layer.

9. The multi-focal pick-up device for an optical storage system of claim 8, wherein the fluid zoom lens further comprises a second electrode, and the second electrode is disposed between the second transparent layer and the third fluid layer.

10. The multi-focal pick-up device for an optical storage system of claim 9, wherein the fluid zoom lens further comprises a second insulating layer and a second dielectric layer, and the second insulating layer and the second dielectric layer are disposed between the second transparent layer and the third fluid layer.

11. The multi-focal pick-up device for an optical storage system of claim 1, further comprises a lens adapted to focusing the light beam.

12. The multi-focal pick-up device for an optical storage system of claim 11, wherein the lens is disposed between the light source and the fluid zoom lens.

13. The multi-focal pick-up device for an optical storage system of claim 11, wherein the fluid zoom lens is disposed between the light source and the lens.

14. The multi-focal pick-up device for an optical storage system of claim 11, wherein the lens is disposed on a surface of the fluid zoom lens wherein the light beam enters.

15. The multi-focal pick-up device for an optical storage system of claim 11, wherein the lens is disposed on a surface of the fluid zoom lens wherein the light beam exits.

16. A fluid zoom lens, comprising:
a fluid chamber, comprising a first transparent layer and a second transparent layer;
a first fluid layer, disposed in the fluid chamber and close to a side of the first transparent layer;
a second fluid layer, disposed in the fluid chamber, and the second fluid layer is between the first fluid layer and the second transparent layer; and
a third fluid layer, disposed in the fluid chamber, and the third fluid layer is between the second fluid layer and the second transparent layer, and the first fluid layer, the second fluid layer, and the third fluid layer filling the fluid chamber, and are being immiscible to each other, wherein an interface between the first fluid layer and the second fluid layer is to form a first curved surface, an interface between the second fluid layer and the third fluid layer is to form a second curved surface, and the first curved surface and the second curved surface being able to be adjusted by providing at least one voltage differential being applied to the first fluid layer, the second fluid layer, and the third fluid layer, so as to form an adjustable curvature for the first curved surface and the second curved surface, respectively.

17. The fluid zoom lens of claim 16, further comprising a first electrode disposed between the first transparent layer and the first fluid layer, a second electrode electrically connected to the second fluid layer, and a third electrode disposed between the second transparent layer and the third fluid layer.

18. The fluid zoom lens of claim 17, further comprising a first insulating layer and a first dielectric layer; the first insulating layer and the first dielectric layer disposed between the first transparent layer and the first fluid layer, and the first dielectric layer further disposed between the first insulating layer and the first fluid layer.

19. The fluid zoom lens of claim 17, further comprising a second insulating layer and a second dielectric layer; the second insulating layer and the second dielectric layer disposed between the second transparent layer and the third fluid layer, and the second dielectric layer further disposed between the second insulating layer and the third fluid layer.

20. The fluid zoom lens of claim 16, further comprising a lens being disposed on a surface of the first transparent layer away from the second transparent layer.

21. The fluid zoom lens of claim 16, further comprising a lens being disposed on a surface of the second transparent layer away from the first transparent layer.

22. A fluid zoom lens, comprising:
a fluid chamber, comprising a first transparent layer and a second transparent layer;
a first fluid layer, disposed in the fluid chamber and close to a side of the first transparent layer; and
a second fluid layer, disposed in the fluid chamber, and the second fluid layer is between the first fluid layer and the second transparent layer, and the first fluid layer and the second fluid layer filling the fluid chamber and are being immiscible in one other, wherein an interface between the first fluid layer and the second fluid layer is to form a curved surface, and the curved surface is adjusted by providing a voltage differential being applied to the first fluid layer and the second fluid layer, so as to form an adjustable curvature.

23. The fluid zoom lens of claim 22, further comprising a first electrode disposed between the first fluid layer and the first transparent layer, and a second electrode electrically connected to the second fluid layer.

24. The fluid zoom lens of claim 22, further comprising an insulating layer and a first dielectric layer, disposed between the first transparent layer and the first fluid layer, and the first dielectric layer being further disposed between the first insulating layer and the first fluid layer.

25. The fluid zoom lens of claim 22, further comprising a lens, disposed on a surface of the first transparent layer away from the second transparent layer.

26. The fluid zoom lens of claim 22, further comprising a lens, disposed on a surface of the second transparent layer away from the first transparent layer.

27. The fluid zoom lens of claim 22, wherein a surface of the first transparent layer facing the first fluid layer is a curved surface.

28. The fluid zoom lens of claim 22, wherein a surface of the first transparent layer facing the first fluid layer is a flat surface.
